(19) United States
(12) Patent Application Publication
(10) Pub. No.: US 2026/0265137 A1
(43) Pub. Date: Sep. 10, 2026

(54) Synthesis of Artificial Lightweight Aggregates using Industrial Waste via Carbon Sequestration

(71) Applicant: SusMax Inc., Philadelphia, PA (US)

(72) Inventors: Mohammad Balapour, Philadelphia, PA (US); Robin Deb, Bethesda, MD (US)

(21) Appl. No.: 19/070,647

(22) Filed: Mar. 5, 2025

(51) Int. Cl. C04B 20/02; C04B 111/00

(52) U.S. Cl. CPC C04B 20/02; C04B 2111/00019

(57) ABSTRACT

The present invention uses waste materials, rich in CaO and MgO, for lightweight aggregate production through carbon mineralization. Carbonation was performed on molded and pelletized aggregates under controlled conditions (~55 oC, 80~84% RH, 15±0.25% CO2 concentration at 1 atm) for a duration ranging between 1 hour to 7 days. While Class C Fly Ash samples exhibited high carbonation efficiency with minimal akermanite content in the final product, steel slag achieved lower efficiency value due to high retention of unreacted calcium silicate phases, necessitating further enhancements for improved reactivity. The carbon mineralization process formed different stable and metastable phases of calcium carbonate, such as calcite, aragonite, and vaterite, in the aggregate microstructure. These carbonates contributed to improved binding between ash particles, enhancing the strength and durability of the aggregates. Overall, the present invention highlights the potential of utilizing industrial by-products for sustainable CO2 sequestration and lightweight aggregate production.

### BACKGROUND OF THE INVENTION

### Field of the Invention

The invention relates to the synthesis of artificial lightweight aggregates using industrial waste via carbon sequestration.

### Description of the Related Art

Over the past few decades, the release of flue gases from industrial activities and rapid urbanization has significantly raised atmospheric carbon dioxide levels, contributing to the accelerated progression of global warming and climate change. For instance, in 2019, it was reported that the concentration of CO₂ in the atmosphere was ~415 ppm, 45% higher in comparison to the concentration levels measured between 1980 to 1990. Another study reported that the CO₂ concentration level during the year 1750 (pre-industrial revolution era) was 280 ppm, which resulted in an average concentration increase of approximately ~0.5 ppm/year. On the contrary, a different study found that the increase in concentration has been exponential over the last decade (i.e., 2 ppm/year), as anthropogenic activities have quadrupled during the span of the last century. Therefore, to restrict the global temperature increase below 2° C., it is critical to offset the emissions, via minimizing the use of fossil fuels for energy and implementing carbon capture and storage technologies (at least 1 Gt of CO₂/year until 2030). To achieve this target, novel energy sources, such as solar, wind, and hydrogen energy are expected to replace the use of fossil fuels, but it will take decades as further technological advancements and widespread adoption is required. On the other hand, CO₂ mineralization offers a convenient solution to accelerate and sequester carbon emissions into stable carbonate forms.

In recent years, production of waste materials, such as waste coal ash, steel slag fines, and incinerated municipal waste and tonnage landfilling has increased exponentially where annual global production exceeds over 1 billion tons. Furthermore, such waste materials pose numerous environmental challenges and health risks, which deems the removal/remediation process a critical factor for developing a sustainable society.

Numerous studies have studied the acceleration of CO₂ mineralization in fly ash and repurposing carbonated materials. After a comprehensive evaluation of water demand, mixing proportions, and strength development over time, the technical feasibility of incorporating carbonated waste materials in form of supplementary additives into concrete composites has been demonstrated as a viable option to sequester CO₂ from the atmosphere and offset emissions related to the construction industry. Studies have also revealed that large fractions of free calcium oxide (CaO) in waste materials need to be present as calcium is integral for CO₂ capturing and carbonate formation. Additionally, there are various innovative pathways for CO₂ mineralization (i.e., direct and indirect mineralization); by modifying mixture reagents and curing conditions, variable degree of carbon uptake can be achieved. However, there are still critical challenges and limitations that need to be addressed before large-scale production can be achieved.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, the present invention is a method of synthesizing artificial aggregates via carbon sequestration. The method comprises the steps of passing base particles through a sieve of not greater than #100 sieve with 0.149 mm openings; adding water to the particles, forming a particle/water paste; adding an alkali to the particle/water paste; and forming pellets from the paste.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is a TGA curve of showing decomposition of different minerals decompositions at specific temperature ranges;

FIG. 2A is a correlation between carbon uptake and degree of carbonation of fly ash (CFA) and steel slag (SS) aggregates for CFA-3H, CFA-6H, and CFA-24H;

FIG. 2B is a correlation between carbon uptake and degree of carbonation of fly ash and steel slag aggregates for SS-3H, SS-6H, and SS-24H;

FIG. 3A is a correlation between carbon uptake and degree of carbonation of fly ash and steel slag aggregates for CFA-1H, CFA-6H, and CFA-24H;

FIG. 3B is a correlation between carbon uptake and degree of carbonation of fly ash and steel slag aggregates for SS-1H, SS-6H, and SS-24H;

FIG. 4A is a picture of an exemplary CFA aggregate;

FIG. 4B is a picture of an exemplary SS aggregate;

FIG. 5A is a scanning electronic image showing formation of a polymorph of calcium carbonate on CFA-3H;

FIG. 5B is a scanning electronic images showing formation of a polymorph of calcium carbonate on SS-24H;

FIG. 6A shows oven dried SS powder after surface modification (SS_SF; and

FIG. 6B shows SS molded aggregate after 24 hours carbonation (SS_SF-24H).

### DETAILED DESCRIPTION

In the drawings, like numerals indicate like elements throughout. Certain terminology is used herein for convenience only and is not to be taken as a limitation on the present invention. The terminology includes the words specifically mentioned, derivatives thereof and words of similar import. The embodiments illustrated below are not intended to be exhaustive or to limit the invention to the precise form disclosed. These embodiments are chosen and described to best explain the principle of the invention and its application and practical use and to enable others skilled in the art to best utilize the invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

The word “about” is used herein to include a value of +/−10 percent of the numerical value modified by the word “about” and the word “generally” is used herein to mean “without regard to particulars or exceptions.”

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Unless explicitly stated otherwise, each numerical value and range should be interpreted as being approximate as if the word “about” or “approximately” preceded the value of the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

### Mechanism of Carbon Mineralization

Utilizing waste flue gases containing substantial concentrations of CO₂ gases for carbon mineralization of alkaline solid waste landfills has been deemed a pragmatic approach for manufacturing. Carbonation of waste materials rich in calcium and magnesium ions (i.e., waste coal ash, steel slag, municipal solid waste), forms thermodynamically solid carbonates, which can be used construction materials. This process has several advantages such as low energy operations, proximity to landfills and waste gas sources, reduction of environmental impact via conversion of inorganic solid waste landfills and creating an economic opportunity through the carbon mineralization process.

The carbonation reaction happens via three main steps as follows:
(i) Calcium ions leaching from the surface of the particles into the aqueous phase,
(ii) CO₂ gas dissolution and formation of carbonate ions (rate-limiting step) and,
(iii) Nucleation and growth of calcium carbonate precipitates.

Once the reaction reaches the precipitation stage, CaCO₃ initial forms an amorphous phase as a colloidal system. However, the stability of this amorphous phase is inadequate to prevent further particle aggregation. Moving forward, particle density increases and the heightened ionic strength of the aqueous phase, leading to gelation of the reaction mixture. This gel phase, held by Van der Waals forces, make the phase unstable and undergoes morphological collapse. Subsequently, gel phase undergoes re-crystallization into vaterite, aragonite, and/or calcite. Depending on the type of reactants, order of reactant introduction into the mixture, the morphological structure of CaCO₃ during the precipitation stage is greatly influenced. Overall, the precipitation of different carbonate minerals can lead to reduction of porosity and permeability on a surface.

Traditional production methods for artificial lightweight aggregates demand significant energy, primarily derived from burning fossil fuels to power the sintering step. This process emits substantial amounts of carbon dioxide into the atmosphere. Therefore, optimizing the carbon sequestration process for manufacturing artificial aggregates has been increasingly regarded as a necessary step to address potential challenges related to global warming and environmental impact as carbonation can occur at lower temperatures (i.e., 50~70° C.), eliminating the need for burning large quantities of fossil fuels. Additionally, by synthesizing stable carbonates in aggregates, it is possible to permanently sequester carbon dioxide from flue gases and entrap industrial emissions into concrete (aggregates occupy 50~60% per unit of volume of concrete). In summary, the rate of carbonation and crystallization depends on several factors. Various operational parameters such as type of waste material, chemical composition, mixture proportions, reaction conditions, time, liquid to solid ratio (L/S), particle size distribution (PSD), and gas flow concentration on sequestration performance (i.e., carbon uptake) were evaluated in a thermo-gravimetric manner. Additionally, scanning electronic images on some specimens were taken to correlate the experimental findings with the formation of carbonates within the microstructure of the aggregates.

### Chemical Composition and Crystallography

Semi-quantitative X-Ray Fluorescence (XRF) analysis was performed on crushed samples (coarse grit grounded to fine powder using mortar and pestle). Loss of ignition (LOI) was determined by heating the sample at 950° C. for 60 minutes, followed by ambient cooling to 25° C. to measure weight loss. Afterwards, ~1 gram of post LOI sample with ~10 grams of lithium borate flux were heated to 1050° C. in a platinum crucible and resultant mix was poured into 40 mm standardized molds for hardening. The XRF test was conducted using a Panalytical MagX PW-2043 Wavelength Dispersive X-RF Spectrometer with Rhodium radiation. The XRF spectra were processed with the fundamental parameters standardless quantification software integrated within the system. This method applied established sensitivity factors for pure elements and accounts for numerous factors such as fluorescence yield, absorption, and enhanced excitation effects. The results (chemical composition of steel slag, class C fly ash, class F fly ash) had been normalized to equal to 100% including the LOI and presented in Class C Fly Ash (“FA”) is defined under ASTM C618 Classification as containing >18% CaO, <6% LOI, SiO2+Fe2O3+Al2O3 minimum 50% of total composition, while Class F FA is defined under ASTM C618 Classification as containing low content of Cao, >6% LOI, SiO2+Fe2O3+Al2O3 minimum 70% of total composition.

Table 1. Class C Fly Ash (“FA”) is defined under ASTM C618 Classification as containing >18% CaO, <6% LOI, SiO2+Fe2O3+Al2O3 minimum 50% of total composition, while Class F FA is defined under ASTM C618 Classification as containing low content of CaO, >6% LOI, SiO2+Fe2O3+Al2O3 minimum 70% of total composition.

TABLE 1
Chemical composition of raw materials used for this study.

Semi-quantitative Crystalline Phase
Analysis (wt. %)

| | Class C | Steel | Class F |
|---|---|---|---|
| | Fly Ash | Slag | Fly Ash |
| SiO₂ | 38.7 | 37.3 | 53.7 |
| Fe₂O₃ | 11.3 | 0.313 | 6.50 |
| CaO | 18.9 | 36.0 | 5.29 |
| MgO | 3.76 | 10.9 | 1.62 |
| Al₂O₃ | 19.4 | 8.04 | 21.8 |
| SO₃ | 1.55 | 1.54 | 0.302 |
| MnO | 0.0414 | 0.568 | 0.0702 |
| K₂O | 1.12 | 0.564 | 1.76 |
| TiO₂ | 1.27 | 0.411 | 1.43 |
| Na₂O | 1.40 | 0.273 | 0.832 |
| ZrO₂ | 0.117 | 0.0632 | — |
| SrO | 0.285 | 0.0585 | 0.134 |
| ZnO | 0.0223 | 0.0074 | 0.0123 |
| P₂O₅ | 0.691 | — | 0.309 |
| BaO | 0.284 | — | 0.106 |
| Y₂O₃ | 0.0076 | — | 0.0107 |
| Loss of Ignition | 1.22 | 3.98 | 6.11 |

X-Ray diffraction (XRD) was performed on crushed samples (coarse particles were grounded to fine powder using mortar and pestle); each sample was loaded onto the sample holder, followed by placement into a Panalytical X′pert MPD diffractometer using Curadiation at 45 kV/40 mA. The scans were run at 20 range of 6° to 80°, with a step size of 0.0131° and an accumulated counting time of 250 seconds per step. Once the diffraction patterns were collected for each sample, crystalline phases were identified using the international center for diffraction data or the inorganic crystal structure database. Additionally, Rietveld refinement method was used for quantitative analysis of the identified crystalline phases, as shown in Table 2. Class C fly ash had approximately 50~80% amorphous content (evidenced by the notable hump in the background of XRD spectra); these values can vary depending on sampling of the actual composition of the amorphous substance.

TABLE 2
Quantitative analysis of the crystalline
phases in steel slag and class C fly ash.

Quantitative Crystalline Phase
Analysis (wt. %)

| | Steel | Class C | Class F |
|---|---|---|---|
| | Slag | Fly Ash | Fly Ash |
| Ca₂(Mg, Al)(Si₂O₇) | 89.4 | 7.7 | — |
| (Akermanite) | | | |
| (Ca, Mg, Al, Fe)₂(Si₂O₆) | 8.8 | — | — |
| (Pyroxene) | | | |
| Ca(SO₄)(H₂O)₂ (Gypsum) | 1.8 | — | — |
| SiO₂ (Quartz) | — | 46.6 | 51.5 |
| Fe₂O₃ (Hematite) | — | 12.3 | 2.9 |
| Fe₃O₄ (Magnetite) | — | 8.8 | 1.9 |
| CaSO₄ (Anhydrite) | — | 6.4 | — |
| (Na, Ca)AlSi₃O₈ | — | — | |
| (Albite/Anorthite) | | | |
| Al₁₀Si₂O₁₉ (Mullite) | — | 18.1 | 21.2 |
| Al₂Si₂O₅(OH)₄(H₂O)₂ | — | — | 3.3 |
| Al₂Si₂O₅(OH)₄ (Kaolinite) | — | — | 5.2 |
| CaCO₃ (Calcite) | — | — | 0.6 |
| *Amorphous Content | absent | present | present |

Based on the XRF and XRD information, it was evident that both types (i.e., steel slag and Class C fly ash) of ashes were suitable for carbon mineralization; alkaline materials containing substantial amounts of CaO (Steel slag: 36.0%, C fly ash: 18.9%)/MgO (Steel slag: 10.9%, C fly ash: 3.8%) have the potential to sequester high capacity of CO₂ from flue gases, rendering them as highly reactive. On the contrary, waste Class F Fly Ash (not conforming to ASTM C618 particle size distribution requirement) contained trace amount of CaO (5.29%)/MgO (1.62%), deeming it unsuitable for carbonation. Modifications in mixing proportions are required to provide sufficient strength in Class F Fly Ash and Steel Slag pellets explained in the following sections.

### Particle Size Distribution

The raw materials were received as coarse particles, which were crushed using a blender to obtain finer particles before sample preparation. To characterize the particle sizes of the ashes selected for this study, laser diffraction analyses were run on respective samples using a Horiba LA950-VA partica analyzer using the wet cell analysis module. Beforehand, the system was aligned and calibrated using clean water. A small fraction of each sample was placed in a beaker, followed by an addition of 5 ml dispersing agent (0.1 wt % sodium meta-phosphate solution). De-agglomeration and mixing were done using a spatula until a consistent paste was formed with an additional 10 mL of sodium meta-phosphate solution. Afterwards, a few ml of water was to the paste mix, followed by a 30-seconds burst of ultrasonic energy exposure. Each treated dispersive sample was introduced into the wet cell using a pipette until acceptable transmittance levels were achieved. The system was then allowed to stabilize, as indicated by a steady response in the real-time histogram. A single measurement of the particle size distribution was recorded, followed by another measurement after 30 seconds. This process was repeated to obtain at least three measurements for each sample. The data was reviewed for consistency, and if deemed reasonable, an average data set was calculated, as shown in Table 3.

TABLE 3
Particle size distribution of ashes used.

| | | | | Standard | | | |
|---|---|---|---|---|---|---|---|
| | Mean | Median | Mode | Deviation | Diameter (μm) | | |
| Sample | (μm) | (μm) | (μm) | (μm) | D₁₀ | D₅₀ | D₉₀ |
| Steel Slag | 66.372 | 17.385 | 12.422 | ±147.180 | 4.879 | 17.385 | 124.332 |
| Class C Fly | 25.385 | 13.505 | 12.334 | ±32.083 | 6.343 | 24.952 | 158.181 |
| Ash | | | | | | | |
| Class F Fly | 58.708 | 24.952 | 10.802 | ±68.007 | 3.740 | 13.505 | 61.983 |
| Ash | | | | | | | |

Table, 4, Table 5, and Table 6 each contains different sample mix proportions, liquid to solid ratio, and procedures. Samples, either molded or pelletized, were cured at ~55° C. and 80~84% relative humidity at a concentration of 15±0.25% CO₂ chamber for 1 hour, 3 hours, 6 hours, 24 hours, and 7 days. The designation of aggregates cured for different time periods and pictures of the samples prepared using steel slag are included in Table 7.

TABLE 4
Preparation parameters, material properties, and liquid
to solid ratio of aggregates prepared using steel slag.

| | Liquid to | |
|---|---|---|
| | Solid Ratio | |
| Sample Type | (L/S) | Comments |
| Steel Slag (100 | 0.16~0.17 | Samples were prepared using mold. |
| wt %) | | Steel Slag particles were crushed to pass |
| | | through the #100 sieve (0.149 mm opening). |
| | | Fine slag particles were mixed thoroughly with |
| | | a gradual addition of water. |
| | | Samples did not gain significant strength |
| | | after 24 hours of carbonated curing. |
| | | Evidently, a minimal carbonation did not help |
| | | with particles bonding. Addition of other |
| | | reagents/alkali activation/particle surface |
| | | modifications were required. |
| Steel Slag (80 | 0.16~0.17 | Samples were prepared using mold. |
| wt %) + Ca(OH)₂ | | Steel Slag Particles were crushed to pass # 30 |
| (20 wt %) | | sieve (600 μm opening). |
| ‘Batch-1’ | | Fine slag particles and slaked lime mixed |
| | | thoroughly with gradual addition of water to |
| | | form consistent paste. |
| Steel Slag (80 | 0.16~0.17 | Samples were prepared using mold. |
| wt %) + Ca(OH)₂ | | Steel Slag Particles were crushed to pass # 200 |
| (20 wt %) | | sieve (0.075 mm opening). |
| ‘Batch-2’ | | Fine slag particles and slaked lime mixed |
| | | thoroughly with gradual addition of water to |
| | | form consistent paste. |
| Steel Slag (80 | 0.16~0.17 | Samples were prepared using the pelletizer. |
| wt %) + Ca(OH)₂ | | Coarse steel slag particles were crushed to |
| (20 wt %) + 2M | | pass #200 sieve (0.075 mm opening). |
| NaOH (‘0’ day | | 2M NaOH concentrated solution was added as |
| particle surface | | liquid, focusing on surface treatment and alkali |
| treatment) | | activation. Pellets were prepared instantaneously. |
| | | Pellets achieved sufficient strength for |
| | | handling. However, mechanical testing was not |
| | | satisfactory. It is possible sieving is causing |
| | | some Ca rich particles to be neglected during |
| | | sample preparation. Ball milling is suggested |
| | | for uniform particle size reduction. |
| Steel Slag (80 | ~0.25 | Samples were prepared using the pelletizer. |
| wt %) + Ca(OH)₂ | | Coarse steel slag particles were crushed to |
| (20 wt %) + 2M | | pass #200 sieve (0.075 mm opening). |
| NaOH (‘1’ day | | 2M NaOH concentrated solution was added as |
| particle surface | | liquid, focusing on surface treatment and alkali |
| treatment) | | activation. Pellets were prepared after 24 |
| | | hours of surface treatment ir sealed |
| | | conditions. |
| Steel Slag (80 | ~0.25 | Samples were prepared using the pelletizer. |
| wt %) + Ca(OH)₂ | | Coarse steel slag particles were crushed to |
| (20 wt %) + 2M | | pass #200 sieve (0.075 mm opening). |
| NaOH (‘4’ day | | 2M NaOH concentrated solution was added as |
| particle surface | | liquid, focusing on surface treatment and alkali |
| treatment) | | activation. Pellets were prepared after 96 |
| | | hours of surface treatment in sealed |
| | | conditions. |
| Steel Slag (80 | 2.0 | Samples were prepared using mold. |
| wt %) + Ca(OH)₂ | | Coarse steel slag particles were crushed to |
| (20 wt %) + 2M | | pass #200 sieve (0.075 mm opening). |
| NaOH (‘4’ day | | 2M NaOH concentrated solution was added as |
| particle surface | | liquid, focusing on surface treatment and |
| treatment) | | alkali activation. Pellets were prepared after |
| | | 96 hours of surface treatment in sealed |
| | | conditions. |
| Steel Slag (80 | ~1.0 | Samples were prepared using the pelletizer. |
| wt %) + Ca(OH)₂ | | Steel slag particles were very fine, and |
| (20 wt %) + 2M | | majority passed #200 sieve (0.075 mm opening). |
| NaCl (‘1’ day | | 2M NaCl concentrated solution was added as |
| particle surface | | liquid, focusing on surface treatment and |
| treatment). | | alkali activation of the particles. Pellets were |
| | | prepared after 24 hours of surface treatment |
| | | of steel slag in sealed conditions. |

TABLE 5
Preparation parameters, material properties, and liquid to
solid ratio of aggregates prepared using class C fly ash.

| | Liquid to | |
|---|---|---|
| | Solid Ratio | |
| Sample Type | (L/S) | Comments |
| Class C Fly Ash | 0.20~0.22 | Samples were prepared using a mold. |
| (100 wt %) | | Fly ash particles passed through the #100 |
| | | sieve (0.149 mm opening). |
| | | Fine ash particles were mixed thoroughly with |
| | | a gradual addition of water. |
| | | Samples did not gain significant strength |
| | | after 24 hours of carbonated curing. |
| | | Evidently, a minimal carbonation did not help |
| | | with particles bonding. Addition of other |
| | | reagents/alkali activation/particle surface |
| | | modifications were required. |
| Class C Fly Ash | 0.20~0.22 | Samples were prepared using a mold. |
| (80 wt %) + | | Class C fly ash particles passed # 30 sieve |
| Ca(OH)₂ (20 wt %) | | (600 μm opening). |
| ‘Batch-1’ | | Fine ash particles and slaked lime mixed |
| | | thoroughly with gradual addition of water to |
| | | form consistent paste. |
| Class C Fly Ash | 0.20~0.22 | Samples were prepared using both mold and |
| (80 wt %) + | | pelletizer. |
| Ca(OH)₂ (20 wt %) | | Class C fly ash particles passed # 200 sieve |
| ‘Batch-2’ | | (75 μm opening). |
| | | Fine ash particles and slaked lime mixed |
| | | thoroughly with gradual addition of water to |
| | | form consistent paste. |

TABLE 6
Preparation parameters, material properties, and liquid to
solid ratio of aggregates prepared using class F fly ash.

| | Liquid to | |
|---|---|---|
| | Solid Ratio | |
| Sample Type | (L/S) | Comments |
| Class F Fly Ash (80 | ~0.25 | Samples were prepared using the pelletizer. |
| wt %) + Ca(OH)₂ | | Fine ash particles were crushed to pass #200 |
| (20 wt %) + 2M | | sieve (0.075 mm opening). |
| NaOH (‘0’ day | | 2M NaOH concentrated solution was added as |
| particle treatment) | | liquid, focusing on surface treatment and |
| | | alkali activation. Pellets were prepared after 0 |
| | | hours of surface treatment in sealed conditions. |
| | | Observation: Particles did not gain sufficient |
| | | structural integrity after carbonation curing, |
| | | suggesting that ash contained low amounts of |
| | | Ca/Mg oxides. Notably, addition of slaked |
| | | lime did work, as sufficient degree of |
| | | carbonation was not achieved. |
| Class F Fly Ash (80 | ~0.25 | Samples were prepared using the pelletizer. |
| wt %) + Ca(OH)₂ | | Fine ash particles were crushed to pass #200 |
| (20 wt %) + 2M | | sieve (0.075 mm opening). |
| NaOH (‘1’ day | | 2M NaOH concentrated solution was added as |
| particle treatment) | | liquid, focusing on surface treatment and |
| | | alkali activation. Pellets were prepared after |
| | | 24 hours of surface treatment in sealed |
| | | conditions. |
| | | Observation: Particles did not gain sufficient |
| | | structural integrity after carbonation curing, |
| | | suggesting that ash contained low amounts of |
| | | Ca/Mg oxides. Notably, addition of slaked |
| | | lime did work, as sufficient degree of |
| | | carbonation was not achieved. |
| Class F Fly Ash (80 | ~0.25 | Samples were prepared using the pelletizer. |
| wt %) + Ca(OH)₂ | | Fine ash particles were crushed to pass #200 |
| (20 wt %) + 2M | | sieve (0.075 mm opening). |
| NaOH (‘4’ day | | 2M NaOH concentrated solution was added as |
| particle treatment) | | liquid, focusing on surface treatment and alkali |
| | | activation. Pellets were prepared after 96 |
| | | hours of surface treatment in sealed conditions. |
| | | Observation: Particles did not gain sufficient |
| | | structural integrity after carbonation curing, |
| | | suggesting that ash contained low amounts of |
| | | Ca/Mg oxides. Notably, addition of slaked |
| | | lime did work, as sufficient degree of |
| | | carbonation was not achieved. |
| Class F Fly Ash (40 | ~0.25 | Samples were prepared using the pelletizer. |
| wt %) + Steel Slag | | Class C and F Fly Ash particles were very fine |
| (20 wt %) + Class | | and majority passed #200 sieve (0.075 mm |
| C Fly Ash (20 | | opening). |
| wt %) Ca(OH)₂ (20 | | Steel Slag particles passing through #30 sieve |
| wt %) + 2M NaOH | | (600 μm opening) were collected for sample |
| (‘4’ day particle | | preparation. |
| treatment of Class | | 2M NaOH concentrated solution was added as |
| F Fly Ash) | | liquid, focusing on surface treatment and alkali |
| | | activation of the particles. Pellets were |
| | | prepared after 96 hours of surface treatment |
| | | of Class F Fly Ash in sealed conditions. |

TABLE 7
Sample designation based on type of ash and duration of curing.

| Duration of Curing | Class C Fly Ash | Steel Slag |
|---|---|---|
| 1-hour | CFA-1H | SS-1H |
| 3-hour | CFA-3H | SS-3H |
| 6-hour | CFA-6H | SS-6H |
| 24-hour | CFA-24H | SS-24H |

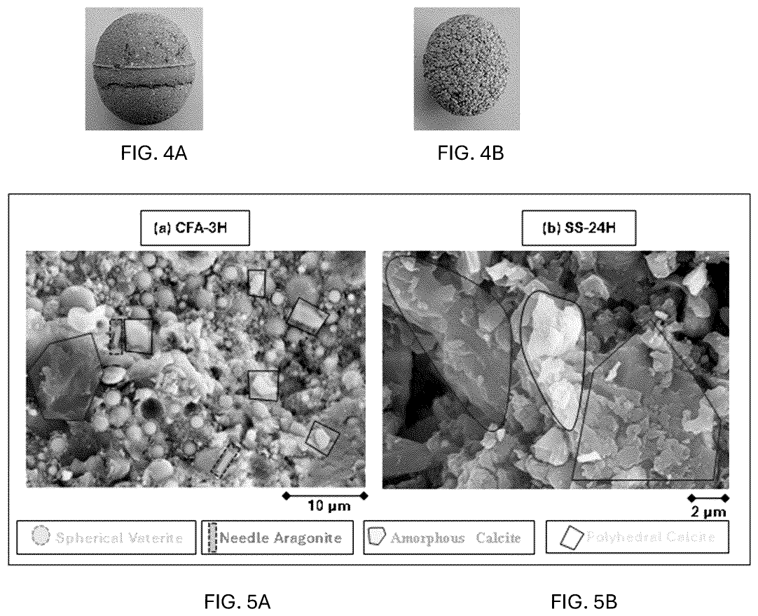

Pictures of exemplary CFA and SS aggregate are shown in FIGS. 4A and 4B, respectively.

### Measurement of CO₂ Uptake

The amount of CO₂ sequestered by mineralization can be calculated by calculating the difference in the weight loss between the mineralized samples and original mass at 105° C. (without moisture). CO₂ uptake and calcination of Ca/Mg were quantified using thermo-gravimetric analysis (TGA). Spherical molded/pelletized aggregates were crushed into fine powdered samples using a mortar and pestle. At 15-20 mg weight sizes, each sample was loaded onto a standard platinum pan, and placed on the sample try of the TA Q-50 Instrument. The following experimental conditions were employed:
Heating rate: 10° C./minute for all ramp segments; data sampling interval: 0.5 sec/point; Balance purge flow (N₂ gas): 60 ml/minute.
Ramp 1:25° C. to 105° C. at 10° C./minute followed by isothermal for 10 minutes.
Ramp 2:105° C. to 500° C./minute at 10° C./minute followed by isothermal for 10 minutes.
Ramp 3:500° C. to 1000° C. at 10° C./minute.

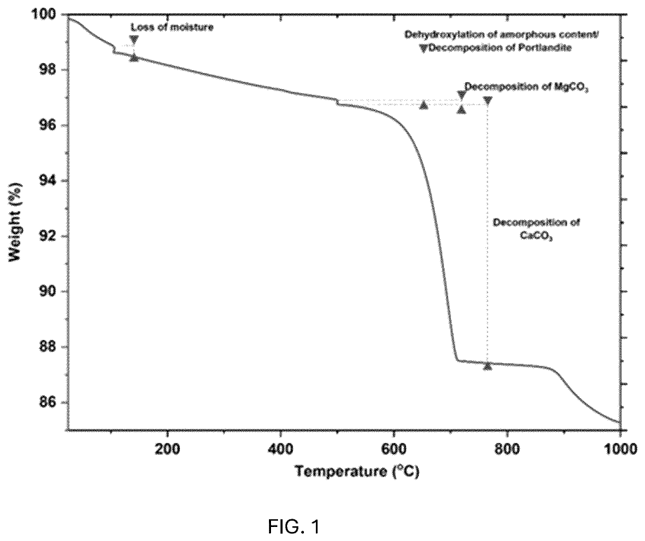

The heating of a sample allows for mass loss differentiation based on the mineral from (i.e., CaCO₃, MgCO₃, Ca(OH)₂, etc.) and moisture/amorphous content, as shown in FIG. 1. Generally, the decomposition of magnesium carbonates, nesquehonite, and hydromagnesite happens between 400 to 500° C. (note that decomposition can start in TGA at as low as 300° C.). Amorphous and poorly crystallized CaCO₃ decomposes between 300 to 630° C., aragonite and vaterite decomposes between 60° and 700° C., and crystalline calcite decomposes between 70° and 850° C. Eq. 1 to Eq. 3 can be used to measure the CO₂ uptake. Additionally, the degree of carbonation/mineralization is a critical indicator of the ability of steel slag/coal ash to sequester CO₂; The conversion of Ca/Mg ions into carbonates/bicarbonates contributes to this degree parameter. Eq. 4 and Eq. 5 can be used to measure the degree using TGA data. Table 8 contains the carbon uptake and degree of carbonation of aggregates cured at different timeframes.

$${CO}_{2} Uptake ( wt . \% ) = \frac{{CO}_{2 carbonated} ( wt . \% ) - {CO}_{2 initial} ( wt . \% )}{100 - {CO}_{2 carbonated} ( wt \% )} \times 100 \% \qquad Eq . 1$$

$${CO}_{2} uptake by MgO ( wt . \% ) = \frac{( wt . \% at 300 °C . ) - ( wt . \% at 500 ° C . )}{( wt . \% at 105 ° C . )} \times 100 \% \qquad Eq . 2$$

$${CO}_{2} uptake by CaO ( wt . \% ) = \frac{( wt . \% at 500 ° C . ) - ( wt . \% at 900 ° C . )}{( wt . \% at 105 ° C . )} \times 100 \% \qquad Eq . 3$$

$${ξ}_{Mg} ( \% ) = \frac{\frac{Δ {m}_{{CO}_{2}}}{{m}_{150 ° C .}}}{1 - \frac{Δ {m}_{{CO}_{2}}}{{m}_{105 ° C .}}} \times \frac{{M}_{MgO} ( \frac{g}{mol} )}{{M}_{{CO}_{2}} ( \frac{g}{mol} )} \times \frac{100}{{MgO}_{total} ( wt . \% )} \times 100 \qquad Eq . 4$$

$${ξ}_{Ca} ( \% ) = \frac{\frac{Δ {m}_{{CO}_{2}}}{{m}_{150 ° C .}}}{1 - \frac{Δ {m}_{{CO}_{2}}}{{m}_{105 ° C .}}} \times \frac{{M}_{CaO} ( \frac{g}{mol} )}{{M}_{{CO}_{2}} ( \frac{g}{mol} )} \times \frac{100}{{CaO}_{total} ( wt . \% )} \times 100 \qquad Eq . 5$$

$$Where ,$$

$$Δ {m}_{{CO}_{2}} = mass loss due to carbonates \\ \\ \\ decomposition ( {MgCO}_{3} decomposition between 300 to 500 ° C . ; \\ {CaCO}_{3} decomposition between 600 to 800 ° C . )$$

$${m}_{105 ° C .} = dry weight of the sample measured at 105 ° C .$$

$${M}_{MgO} = molecular weight of MgO ( 40.3 g / mol ) .$$

$${M}_{CaO} = molecular weight of CaO ( 56 g / mol ) .$$

$${M}_{{CO}_{2}} = molecular weight of {CO}_{2} ( 44 g / mol ) .$$

$${MgO}_{total} ( wt . \% ) = weight fraction of MgO in raw materials ( i . e . , fly ash or steel slag ) .$$

$${CaO}_{total} ( wt . \% ) = weight fraction of CaO in raw materials ( i . e . , fly ash or steel slag ) .$$

TABLE 8
Carbon Uptake and degree of carbonation of molded single aggregate.

| | Class C fly | Degree of | | Steel Slag, | Degree of | |
|---|---|---|---|---|---|---|
| Duration | ash, M_{CO2} (g/g | carbonation | | M_{CO2} (g/g | carbonation | |
| of curing | of Agg.) | ξ(MgO) | ξ(CaO) | of Agg.) | ξ(MgO) | ξ(CaO) |
| | Batch 1 | | | Batch 1 | | |
| 3 hour | 0.10 ± 0.01 | 0.19% | 25.02% | 0.06 ± 0.004 | 0.23% | 4.59% |
| 6 hour | 0.11 ± 0.001 | 0.21% | % | 0.081 ± 0.01 | 0.21% | 6.94% |
| 24 hour | 0.119 ± 0.01 | 0.16% | 30.69% | 0.11 ± 0.001 | 0.10% | 15.04% |
| | Batch 2 | | | Batch 2 | | |
| 1 hour | 0.043 ± 0.01 | 0.18% | 3.16% | 0.04 ± 0.01 | 0.17% | 2.86% |
| 3 hour | | | | 0.05 ± 0.001 | 0.17% | 1.43% |
| 6 hour | 0.115 ± 0.001 | 0.24% | 25.83% | | | |
| 24 hour | 0.118 ± 0.001 | 0.22% | 30.31% | 0.09 ± 0.002 | 0.11% | 10.30 |

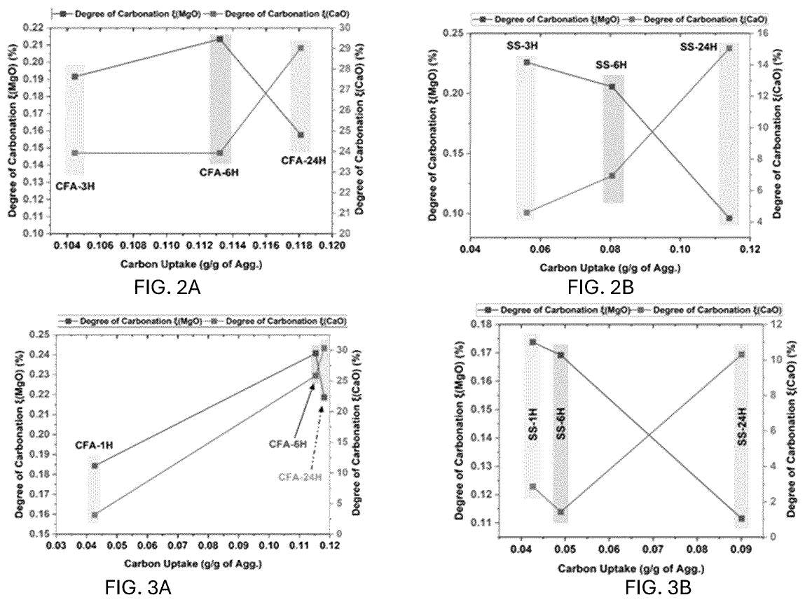

FIGS. 2A, 2B, 3A, and 3B the relationship between degree of carbonation and carbon uptake of CFA and SS samples of ‘batch-1’ and ‘batch-2’ (see Table 4 and Table 5). A fundamental difference between batch-1 and batch-2 of SS samples was the particle size as it was hypothesized that smaller particle size of steel slag would offer more surface area for CO₂ mineralization. In simple terms, as CO₂ diffused into the solid-liquid phase, smaller particles allow high leachability and increase the concentration of available calcium/magnesium ions, promoting higher degree of carbonation. However, in this study, the majority of the calcium ions were locked in insoluble phases (i.e., akermanite). On another note, both SS and CFA samples exhibited maximum carbon uptake and degree of carbonation at 24 hours, suggesting longer exposure to CO₂ enables high degree of carbonate formation. Ca²⁺/Mg²⁺ reacts with carbonate ions to form Ca/MgCO₃, depositing a layer of carbonates on the fly ash/steel slag particles. Notably, degree of carbonation of MgO decreased significantly for both steel slag and class C fly ash samples. Nevertheless, the formation of calcium carbonate is crucial as it directly contributes to strength development.

Additionally, theoretical CO₂ sequestration capacity (i.e., ^{Thm′}CO₂) of waste coal fly ash or steel slag can be calculated using Eq. 5, which takes the chemical composition into consideration. For steel slag it was 0.5132 g/g of Agg., and waste coal fly ash 0.2719 g/g of Agg., respectively.

Table 9 outlines all the uptake efficiency values of cured aggregates at different timeframes calculated using Eq. 6. Evidently, improvement is required on steel slag samples; although steel slag particles has 36.0% of CaO, majority of it is locked in unreacted akermanite (Ca₂Mg(Si₂O₇) form; based on XRD characterization steel slag samples after 1 hour, 3 hours, 6 hours, and 24 hours of carbonation had 73.3%, 71.2%, 66.5%, and 61.9% mass fraction of akermanite still remained in the tested samples. In contrast, class C fly ash samples had akermanite ranging between 3.1 to 3.6% after carbonation. Calcium and magnesium silicates are abundantly found in nature and hold large potential to sequester CO₂. However, natural mineralization is a slow process unless some form weathering/surface modification is introduced into the system. Several studies have experimented with using organic/inorganic acids and other chemical reagents to extract calcium ions from the silicate phases.

$${Thm}_{{CO}_{2}}^{′} ( g / g of Agg . ) = [ \frac{44}{56} ( {m}_{CaO} - \frac{56}{80} \times {m}_{{SO}_{3}} ) + \frac{44}{40} {m}_{MgO} + \frac{44}{70} {m}_{{Ca ( OH )}_{2}} ] \times 100 \qquad Eq . 5$$

$$ϵ ( \% ) = \frac{{M}_{{CO}_{2}}}{{Thm}_{{CO}_{2}}^{′}} \times 100 \qquad Eq . 6$$

TABLE 9
Carbonation efficiency of aggregates made
from Class C fly ash and steel slag.

| | |
|---|---|
| Class C fly ash, M_{CO2} | Steel Slag, Mco2 |
| (g/g of Agg.) | (g/g of Agg.) |

| | |
|---|---|
| Duration of Curing | Efficiency, ε (%) |

Batch 1

| | | | |
|---|---|---|---|
| 3 | hour | 38.25 | 10.92 |
| 6 | hour | 41.56 | 15.78 |
| 24 | hour | 43.77 | 22.21 |

Batch 2

| | | | |
|---|---|---|---|
| 1 | hour | 15.82 | 8.09 |
| 3 | hour | — | 9.22 |
| 6 | hour | 41.20 | — |
| 24 | hour | 42.28 | 16.94 |

### Measurement of Aggregate Strength

Aggregate in concrete mixture designs reduce the consumption of binders (i.e., cement and water), provides compaction and mechanical strength. Typically, manufactured fly-ash based lightweight aggregates have higher porosity compared to natural aggregates (stone and gravel; aggregate strength: 50 to 300 MPa), which contributes to lower strength value (i.e., 5 to 20 MPa). Nevertheless, lightweight aggregates provide adequate strength and dimensional stability for specific concrete applications, such as pre-cast blocks, thermal, and acoustic insulation. In this case, carbonation curing converts the free calcium ions into calcium carbonates by reacting with carbon dioxide, which acts as binding agents between waste ash particles of lightweight aggregates, improving strength and durability. Aggregates prepared from different types of ashes, as mentioned above, were tested for compression using a 500N Digital Force Gauge Push Pull device. The device can be used to apply axial force on a spherical aggregate specimen until failure; subsequently, the device records the maximum force at the point of break (Pₘₐₓ). Using Eq. 7, crushing strength of aggregates (molded and pelletized) were calculated.

$$Crushing {Strength}_{max} = \frac{2.8 {P}_{max}}{π {d}^{2}} \qquad Eq . 7$$

Table 10 shows the compressive strength values of molded aggregates of ‘Batch-1’. CFA samples demonstrated higher strength gain over 3 hours, 6 hours, and 24 hours of carbonation compared to SS sample due to its' inherent hydraulic properties. In addition, formation of CaCO₃ crystals within the aggregate matrix of CFA samples strengthens the amorphous phase (i.e., C-A-S-H) and contributes to strength gain. The micron sized calcium carbonate crystals interlock itself in the binding amorphous phase, forming a denser and compact microstructure. Another reasoning behind lower strength gain of SS samples was due to low degree of carbonation/low carbonation efficiency and lack of hydraulic phase. Despite having significantly higher Ca content, most of the available Ca were locked in insoluble akermanite phase, and thus failing to achieve sufficient calcium carbonate formation. Table 11 represents the compressive strength values of molded and pelletized samples of CFA and SS samples cured under carbonated conditions for 1 hour, 6 hour, 24 hours, and 7 days (only of SS). As observed with Batch-1, CFA samples (both molded and pelletized) achieved 15.6% to 71. 8% higher strength compared to SS samples. Notably, for each type, molded specimens were able to attain higher strength than pelletized; this additional strength gain can be attributed towards extra compaction required for molded samples, resulting in more strength.

Table 12 displays the compressive strength values of pelletized composite samples (Scash+SS+CFA) with 2M NaOH surface treatment. As reference, to observe effect of surface modification using NaOH, fine steel slag particles were used to prepare additional samples for carbonation. Scash+SS+CFA strength gain was less than 50% of SS samples with surface modification; despite of having SS and CFA in the composite mix, surface modification did not perform as well as it was hypothesized. Further investigation is required.

TABLE 10
Compressive strength of single aggregate
(molded - Batch 1; one sample).

| | | |
|---|---|---|
| Duration of Curing | Class C fly ash | Steel Slag |

| | | | | | |
|---|---|---|---|---|---|
| 3 | h | 1.70 | MPa | 1.10 | MPa |
| 6 | h | 1.93 | MPa | 1.81 | MPa |
| 24 | h | 1.86 | MPa | 1.48 | MPa |

TABLE 11
Compressive strength of single aggregate (molded and pelletized -
Batch 2; each value for molded represents an average of 3 samples
with one exception; each value for pelletized represents an
average of 10 samples).

| Duration | | Class C fly ash | | Steel Slag | |
|---|---|---|---|---|---|
| of Curing | | Molded | Pelletized | Molded | Pelletized |
| 1 | hour | 2.76 MPa | 2.40 ± 0.03 | — | 1.57 ± 0.29 |
| | | (one sample) | MPa | | MPa |
| 6 | hour | 0.93 ± 0.23 | 2.54 ± 0.80 | 1.83 ± 0.12 | 1.49 ± 0.38 |
| | | MPa | MPa | MPa | MPa |
| 24 | hour | 2.49 ± 0.27 | 2.06 ± 0.57 | 0.70 ± 0.20 | 0.69 ± 0.23 |
| | | MPa | MPa | MPa | MPa |
| 7 | days | — | — | — | 0.75 ± 0.21 |

MPa

TABLE 12
Compressive strength of single aggregate (pelletized-
Batch 3-tested after 7 days of CO₂ curing; each
value represents an average of 10 samples).

| ScAsh (40%) + SS(20%) + | SS(80%) + Ca(OH)₂(20%) + |
|---|---|
| CFA(20%) + Ca(OH)₂ (20%) + 96 | 96 Hours of Treatment |
| Hours of Treatment with 2M NaOH | with 2M NaOH |
| Pelletized | Pelletized |
| 0.21 ± 0.07 MPa | 0.45 ± 0.17 MPa |

### Scanning Electron Microscopy of Carbonated Aggregates

Scanning electron microscopic (SEM) analysis was performed using a ZEISS SUPRA 50VP SEM to observe the microstructure and confirm formation of calcium carbonates of aggregates made from different waste fly ash/steel slag sources. Single aggregates after carbonation were dried and placed in containers for submersion in low-viscosity epoxy. Afterwards, the specimen containers were subjected to vacuum conditions for approximately ~10 minutes; this step was critical to ensure entrapped air bubble removal and successful epoxy resin penetration into the pore structure. Followed by a curing process of 24 hours, the epoxy-fixated specimens were cut at the mid-cross-section of the aggregates using a diamond saw. Next, the cut-surfaces were polished using #400, #600, #800, and #1200 paper to smoothen the surface. Furthermore, specimens were sputter coated using platinum at a 10~15 nm thickness. Depending on median particle size and crystal shape, calcium carbonates polymorphs have filler effect within the microstructure, and thus can have variable strength properties.

FIGS. 5A and 5B each shows the SEM images of CFA-3H and SS-24H microstructure, respectively. Evidently, both samples exhibited evidence of formation of calcium carbonate polymorphs after 3 hours and 24 hours of carbonation. Typically, calcite (CaCO₃) forms a polyhedral crystal after complete maturation from the amorphous phase. Aragonite appears as prisms or needlelike crystals. Vaterite, another form of calcium carbonate, tends to form polycrystalline spherulites which are less than 1 μm in diameter. Both amorphous phase and metastable phase (aragonite and vaterite) act as pre-cursor before forming complete crystalline calcite. As mentioned above, chemical composition, mixture proportions, reaction conditions, supersaturation level, ionic ratio of Ca²⁺/CO₃²⁻ and kinetics of reactions play a critical role in the formation of calcium carbonates polymorphs and the particle size distribution in the aggregate matrix. Depending on median particle size and crystal shape, calcium carbonates polymorphs have filler effect within the microstructure, and thus can have variable strength properties.

### Water Absorption Capacity

The absorption capacity of aggregates is the change in mass after submersion of dried aggregate into water for a period of 24 to 72 hours, which allows ingress of liquid phase into the pore spaces (connected and disconnected). This absorption capacity parameter is used as an indicator of the porosity of the aggregate, which influences its performance in concrete and other applications. The formula for calculating the percent water absorption of aggregates is shown in Eq. 8. Table 13 and Table 14 each shows the absorption capacity of carbonated aggregates prepared using Class C Fly Ash and Steel Slag (Batch 1 and Batch 2). Aggregates obtained from both batches behaved similarly to lightweight aggregates, in respect to absorption capacity.

$$Water Absorption ( \% ) = \frac{{M}_{SSD} - {M}_{OD}}{{M}_{OD}} \times 100 \qquad Eq . 8$$

$$Where ,$$

$${M}_{SSD} = Mass of saturated surface dried aggregate .$$

$${M}_{OD} = Mass of oven - dried aggregate at 105 ° C .$$

Table 13 and Table 14 contain the average absorption capacity values of CFA and SS aggregates from batch-1 and batch-2. Notably, aggregates prepared at batch-1 demonstrated substantially higher values. A possible reasoning behind such observation can be the particle size distribution. SS samples prepared in batch-2 were less than 75 μm in diameter, suggesting improved particle packing fraction. Moreover. CFA samples in batch-2 demonstrated similar values in 6 hours and 24 hours, indicating the correlation between maximum carbon uptake and consistent porosity. On the contrary, SS samples exhibited variable absorption capacity, suggesting the calcium carbonates polymorphs may affect the pore network and overall porosity.

TABLE 13
72-hour absorption capacity of single aggregate (each
value represents an average of 3 samples), batch-1.

| | |
|---|---|
| Class C fly ash | Steel Slag |

| | |
|---|---|
| Duration of curing | Molded samples |

| | | | |
|---|---|---|---|
| 3 | h | 16.32 ± 0.44% | 12.25 ± 3.82% |
| 6 | h | 22.88 ± 3.56% | 14.56 ± 4.83% |
| 24 | h | 27.35 ± 0.41% | 19.17 ± 0.65% |

TABLE 14
72-hour absorption capacity of single aggregate (each
value represents an average of 3 samples), batch-2.

| | |
|---|---|
| Class C fly ash | Steel Slag |

| | |
|---|---|
| Duration of curing | Molded & Pelletized samples |

| | | | |
|---|---|---|---|
| 1 | h | 7.40 ± 1.36% | 11.72 ± 2.19% |
| 6 | h | 13.52 ± 2.88% | 13.40 ± 1.26% |
| 24 | h | 12.30 ± 0.09% | 11.65 ± 2.49% |

### Acid Leaching and Improvement in Carbon Uptake

As indicated with XRD results, a significant portion of calcium was locked up in crystalline phases (i.e., akermanite) which prevented further CO₂ uptake for the steel slag-based aggregate (i.e., SS). Therefore, to increase the carbon uptake, surface modification of fine steel slag particles using acidic acid solutions can be a viable pathway1,2.

### Sample Preparation-1st Phase

‘Steel slag’ sample was dried and grounded for passing no. 200 sieve. 10 g samples were dissolved in 1 M Acetic acid solution containing 0.10 moles of acetic acid (SS_SF_1MAceticAcid) and using the Calcium ion probe, calcium concentration was measured periodically. Additionally, a controlled solution using 10 g samples and 100 ml distilled water (SS_Baseline) were also prepared as to measure the baseline for leaching calcium without acid addition. L/S (liquid to solid) ratio was kept at 10. To determine the leaching yield (R) of calcium over time, the following equation was used3:

$$R = ( {C}_{Ca} \times {M}_{Ca} \times V ) / ( m \times {w}_{Ca} ) \times 100 \% \qquad Eq . 8$$

$$Where ,$$

$${C}_{Ca} = concentration of {Ca}^{2 +} in the leachate ( mol . {L}^{- 1} ) ,$$

$${M}_{Ca} = molar mass of calcium ( g / mol ) ,$$

$$V = volume of the leachate ( L )$$

$$m = mass of minerals powder ( g ) ,$$

$${w}_{Ca} = stoichiometrical mass fraction of Ca in the minerals .$$

Table 15 shows the calcium ion concentration, and leaching yield values of ‘SS_Baseline’ and ‘SS_SF_1MAceticAcid’ samples at 0, 18, and 24 hours. For both samples, longer duration of wetting with liquid phases allowed calcium ions dissolving and leaching. Notably, addition of acetic acid lowered the pH to 4~5, which increased the leaching yield by 4 times, in contrast to SS-Baseline.

TABLE 15
Calcium ion concentration and leaching yield
over a period of 24 hours at L/S ratio of 10.

| | Ca²⁺ concentration (mol/L) | | Leaching Yield, R (%) | |
|---|---|---|---|---|
| Time | | SS_SF_{—} | | SS_SF_{—} |
| (Hour) | SS_Baseline | 1MAceticAcid | SS_Baseline | 1MAceticAcid |
| 0 | 5.60 | 16.15 | 7.62 | 21.97 |
| 18 | 11.27 | 47.89 | 15.34 | 65.15 |
| 24 | 11.74 | 44.72 | 15.96 | 60.85 |

*SS_Baseline: Steel slag powder with distilled water (L/S = 10).
*SS_SF_1MAceticacid: Steel slag powder with acetic water (L/S = 10).

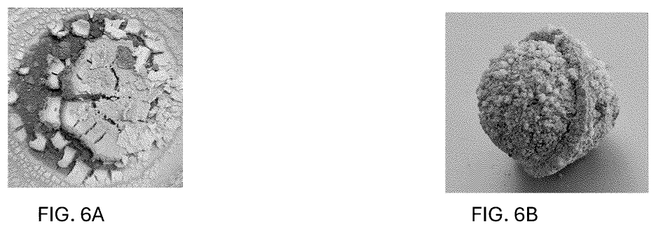

Molded pellets were prepared using steel slag after surface modification (SS_SF) ash after drying (no. 200 80% ash+20% Ca(OH)₂), L/S=0.324. Carbonation duration was 24 hours at the 55 oC at 80~84% relative humidity. FIG. 6(a)-(b) show the steel slag after surface modification (dried at 105° C. for 24 hours to evaporate the liquid phase) and molded aggregate after carbonation. Thermogravimetric analysis was performed on the SS_SF-molded aggregate by homogenizing using a mortar and pestle to obtain a holistic representative of the sample. SS_SF-molded aggregate exhibited 0.150 g/g of Agg. Carbon uptake, yielding an improved carbonation efficiency of 29.23%. However, the strength was not sufficient, as the aggregate broke under slight pressure. Some possible reasons are as follows1,3-5:

Loss of reactive phases in steel slag: Slag may have C3S and C2S phases, which contribute to strength development during hydration, alike cementitious materials. Excessive exposure to acid may result in removal of too much calcium and degradation of silicate phases, which can be a limiting factor.

Increase of porosity due to excessive leaching: Excessive surface modification increases the porosity of slag particles, which impacts the mechanical integrity as particle-to-particle bonding within the aggregate matrix can be weakened.

Carbonation Depth: Carbonated products may have formed mainly on the surface of the aggregate rather than forming as effective binder between slag particles.

Inadequate binding phase formation: Although acetic acid effectively leached calcium out of slag particles, formation of undesirable polymorphs (vaterite or aragonite) led to weak binding phase formation, which yielded lower strength.

### CONCLUSIONS

Several types of industrial waste materials were selected to test the feasibility of manufactural lightweight aggregates via carbon sequestration process. The following are the conclusions based on the observations made are as follows:

Suitability of raw materials: Class C fly ash and steel slag were found to be favorable for carbon mineralization due to their high mass fraction of reactive materials, such as CaO (36.0% in steel slag, 18.90% in Class C fly ash), and MgO (10.9% in steel slag, 3.8% in Class C Fly ash). Alternatively, a type of Class F fly ash was experimented with to form aggregates using carbonation process. However, with substantial addition of Portlandite and other Ca-rich materials, sufficient structural integrity was not achieved.

Curing Process and Carbonation efficiency: Molded and pelletized samples prepared using Class C fly ash and steel slag were cured at ~55° C. at 80~84% RH with 15±0.25% CO₂ concentration at 1 atm pressure ranging between 1 hours to 7 days. Both steel slag and Class C Fly ash samples exhibited maximum carbon uptake after 24 hours of curing. However, steel slag demonstrated lower carbonation efficiency despite of having higher mass fraction of calcium oxide in comparison to Class C Fly ash. XRD results after carbonation revealed that the majority of calcium is locked in calcium silicate phases (i.e., akermanite), and yielding low degree of carbonation. Therefore, activation/surface treatment of steel slag samples is necessary to improve efficiency as it can improve calcium ion extraction and reactivity. The surface treatment is achieved by the addition of a suitable surface modifying chemical at liquid phase at correct concentration disintegrates the silicates, allowing Calcium ions to dissolute into the solution, which enhances degree of carbonation. This can be done by the addition of a suitable surface treatment liquid agent to very fine particles of steel slag at a liquid to solid ratio between 0.2 to 2.

Aggregate Strength, Porosity, and Crystal Morphology in Microstructure: Carbonated steel slag aggregates exhibited strength gain of 1 to 2 MPa variable curing conditions. However, compared to Class C fly ash aggregates, strength values of steel slag were substantially lower, indicating correlation between carbonation efficiency and strength gain. SEM characterization in aggregate microstructure revealed that carbon mineralization forms different stable and metastable phases of calcium carbonate. Depending on mixture proportions, chemical composition, and curing duration under CO₂, the formation of these calcium carbonate phases is heavily influenced, which can affect the strength development and pore network of aggregates.

Addition of low pH surface modifying agents were successful in leaching out calcium ions from insoluble silicate phases from steel slag (i.e., akermanite) over 24 hours exposure. However, although improved carbon uptake was achieved, the surface modified molded aggregate was not sufficiently strong. This is a possible indication that excessive calcium leaching has occurred, resulting in porosity development, undesired calcite morphological formation, and loss of reactive phases in steel slag. Concentration of surface modifying chemicals, liquid to solid ratio, exposure time, and curing conditions need to be further optimized to achieve a balance between carbon uptake, and strength development in the aggregate.

In summary, this invention demonstrates that Ca-rich and Mg-rich waste materials hold significant potential for carbon mineralization and manufacturing lightweight aggregates for concrete. Carbon mineralization improves the binding between fine waste particles and provides strength to the aggregates by forming stable and metastable phases of calcium carbonate in the microstructure. As aggregates occupy 50 to 60% volume in a typical concrete mix, by incorporating such aggregates, it is feasible to sequester significant proportion of industrial CO₂ emissions into building materials, which in turn contributes to environmental sustainability. Future work should be focused on optimizing reaction conditions, improving calcium ion extraction from silicate phases of waste materials, improving carbonation efficiency, and exploring alternative chemical additives.

It will be further understood that various changes in the details, materials, and arrangements of the parts which have been described and illustrated in order to explain the nature of this invention may be made by those skilled in the art without departing from the scope of the invention as expressed in the following claims.

We claim:

1. A method of synthesizing artificial aggregates via carbon sequestration comprising the steps of:
(a) passing base particles through a sieve of not greater than #100 sieve with 0.149 mm openings;
(b) adding water to the particles, forming a particle/water paste;
(c) adding an alkali to the particle/water paste; and
(d) forming pellets from the paste.

2. The method according to claim 1, further comprising the step of activation/surface treating of the base particles.

3. The method according to claim 2, wherein the base particles comprise steel slag.

4. The method according to claim 3, wherein the base particles further comprise Ca(OH)₂.

5. The method according to claim 4, wherein the base particles further comprise NaOH.

6. The method according to claim 3, wherein the steel slag comprises CaO.

7. The method according to claim 3, wherein the steel slag comprises MgO.

8. The method according to claim 2, wherein the base particles comprise Class C fly ash.

9. The method according to claim 8, wherein the base particles further comprise Ca(OH)₂.

10. The method according to claim 9, wherein the base particles further comprise NaOH.

11. The method according to claim 2, wherein the base particles comprise Class F fly ash.

12. The method according to claim 11, wherein the base particles further comprise Ca(OH)₂.

13. The method according to claim 12, wherein the base particles further comprise NaOH.

14. The method according to claim 1, wherein step (c) comprises combining the alkali with atmospheric CO₂.
